(19) United States
(12) Patent Application Publication
(10) Pub. No.: US 2007/0214374 A1
(43) Pub. Date: Sep. 13, 2007

(54) ULTRA LOW POWER SYSTEM FOR SENSOR NETWORK APPLICATIONS

(76) Inventors: Mark Hempstead, Cambridge, MA (US); Nikhil Tripathi, Noida (IN); Patrick Gerard Mauro II, Wake Forest, NC (US); Gu-Yeon Wei, Cambridge, MA (US); David Brooks, Cambridge, MA (US)

Correspondence Address: 24IP LAW GROUP USA, PLLC, 12 E. LAKE DRIVE, ANNAPOLIS, MD, 21403, US

(21) Appl. No.: 11/685,721

(22) Filed: Mar. 13, 2007

Related U.S. Application Data
(60) Provisional application No. 60/781,929, filed on Mar. 13, 2006.

(51) Int. Cl. G06F 1/00

(52) U.S. Cl. 713/300

(57) ABSTRACT

A system for sensor network applications comprising a microcontroller for handling irregular events, at least one hardware accelerator for handling regular events, an event processor for interrupt handling and power management in the system, and a system bus. The microcontroller, hardware accelerator, and event processor each are connected to the system bus. The event processor gates power to the microcontroller to provide power to the microcontroller only for processing related to irregular events requiring processing by the microcontroller. The event processor further may gate power to the hardware accelerator. The system may further include a message processor and a plurality of sensors.

### CROSS-REFERENCE TO RELATED APPLICATIONS

The present application claims the benefit of the filing date of U.S. Provisional Application Ser. No. 60/781,929 entitled “An Ultra Low Power System Architecture for Sensor Network” and filed on Mar. 13, 2006.

The above cross-referenced related application is hereby incorporated by reference herein in their entirety.

### STATEMENT REGARDING FEDERALLY SPONSORED RESEARCH OR DEVELOPMENT

This work was supported by National Science Foundation Grant No. 0330244.

### BACKGROUND OF THE INVENTION

1. Field Of The Invention

The present invention relates to the architectural design and implementation of wireless sensor devices.

2. Brief Description Of The Related Art

Wireless sensor networks are poised to transform the way society interacts with the physical world, driven by an explosion of systems research in sensor networks. Sensor networks have been proposed and deployed for a wide variety of applications such as habitat monitoring (A. Mainwaring, J. Polastre, R. Szewczyk, D. Culler, and J. Anderson, “Wireless sensor networks for habitat monitoring,” ACM International Workshop on Wireless Sensor Networks and Applications (WSNA '02), Atlanta, Ga., September 2002 and R. Szewczyk, J. Polastre, A. Mainwaring, and D. Culler, “Lessons from a sensor network expedition,” Proc. the First European Workshop on Wireless Sensor Networks (EWSN), January 2004), structural monitoring, and emergency medical response (T. R. F. Fulford-Jones, G.-Y. Wei, and M. Welsh, “A Portable, Low-Power, Wireless Two-Lead EKG System,” In Proceedings of the 26th IEEE EMBS Annual International Conference, San Francisco, Calif., September 2004 and K. Lorincz, D. Malan, T. R. F. Fulford-Jones, A. Nawoj, A. Clavel, V. Shnayder, G. Mainland, S. Moulton, and M. Welsh, “Sensor networks for emergency response: Challenges and opportunities,” IEEE Pervasive Computing, October-December 2004). While the application space seems limitless, it is actually limited by the operating lifetime of the battery-operated wireless sensor nodes. Current deployments rely on commercially available wireless sensor network devices (e.g., Mica2 (Crossbow Technology Inc. Mica2 sensor node. http://www.xbow.com)). Such devices typically consist of a basic microcontroller, a radio, and a variety of (often MEMS-based) sensors. One of the main limitations of these platforms is that they are built using commodity chips, which themselves are not specifically designed for wireless sensor networks. As a result, they suffer several inefficiencies that lead to high power consumption and limited operational lifetimes.

To address this limitation, the present invention presents the design and analysis of an ultra low power device specifically for sensor network applications. In these systems, the CPU, radio, and sensor devices are responsible for the majority of the total system power and we show that the general purpose nature of commodity microcontrollers results in inefficient power usage, presenting an opportunity to significantly reduce its power.

Several organizations are actively involved in designing hardware for sensor network devices. The devices that have been used widely for research and in some commercial deployments, such as the Mica2 and Telos (J. Polastre, R. Szewczyk, C. Sharp, and D. Culler, “The Mote Revolution: Low Power Wireless Sensor Network Devices,” In Hot Chips 16: A Symposium on High Performance Chips, August 2004) motes, employ general-purpose microcontrollers that do not efficiently handle interrupt processing. However, the primary task of a sensor network device is to handle timer and external interrupts since their applications are inherently event driven (J. Hill, “System Architecture for Wireless Sensor Networks,” PhD thesis, UC Berkeley, May 2003). Therefore, these devices must run an event driven operating system (TinyOS (J. Hill, R. Szewczyk, A. Woo, S. Hollar, D. E. Culler, and K. S. J. Pister, “System architecture directions for networked sensors,” Architectural Support for Programming Languages and Operating Systems, pages 93-104, 2000 )) to mask the deficiencies of the hardware platforms that have not been designed specifically for sensor networks.

The first custom device for sensor networks is the Spec architecture, which includes hardware accelerators for tasks such as message start-symbol detection. In fact, the newer generation radio chips incorporate some of these features (Chipcon AS. CC2420 2.4 GHz IEEE 802.15.4/ZigBee-ready RF Transceiver. http://www.chipcon.com). The SNAP architecture, which is an asynchronous design initiative described in V. Ekanayake, I. Clinton Kelly, and R. Manohar, “An ultra low-power processor for sensor networks,” Proc. ASPLOS, October 2004, is an example of an event-driven architecture for sensor network devices. However, the SNAP architecture does not exploit the powerful event-driven paradigm apart from getting rid of the TinyOS overhead. In other words, its primary computing engine is still a general purpose microcontroller that must remain powered on all the time, even when events occur rarely, thereby incurring leakage power.

The Smart Dust project out of UC Berkeley developed a general-purpose microcontroller with low-power design techniques for use in a sensor network device (B. A. Warneke and K. S. Pister, “An ultra-low energy microcontroller for smart dust wireless sensor networks,” Proc. ISSCC, January 2004.) All known architectures for wireless sensor network devices fail to optimize common-case behavior of applications, because they all suffer from the overly general purpose nature of the primary computing engines.

### SUMMARY OF THE INVENTION

In a preferred embodiment, the present invention is a system for sensor network applications comprising a microcontroller for handling irregular events, at least one hardware accelerator for handling regular events, an event processor for interrupt handling and power management in the system, and a system bus. The microcontroller, hardware accelerator, and event processor each are connected to the system bus. The event processor gates power to the microcontroller to provide power to the microcontroller only for processing related to irregular events requiring processing by the microcontroller. The event processor further may gate power to the hardware accelerator. The system may further include a message processor and a plurality of sensors.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a block diagram of a system architecture in accordance with a preferred embodiment of the present invention.

FIG. 2 is a diagram of an event processor state machine in accordance with a preferred embodiment of the present invention.

FIG. 3 is a diagram and code of a monitoring application in accordance with a preferred embodiment of the present invention. The code displayed are the ISR routines for the event processor.

FIG. 4 is a diagram of estimated power varying node duty cycle sample application in accordance with a preferred embodiment of the present invention. A duty cycle of 1.0 is roughly 800 tasks per second.

### DETAILED DESCRIPTION OF THE PREFERRED EMBODIMENTS

In contrast to the prior systems, the present invention seeks to fully leverage the event-driven nature of applications in the design of next generation low-power sensor network nodes. Scavenging energy from the environment and using this energy to power the sensor network device greatly increases the effective lifetime of a wireless sensor node.

There are many sources of energy available in the environment such as solar, vibration, and electromagnetic radiation, and researchers have developed techniques to harness this energy (S. Roundy, P. K. Wright, and J. Rabaey, “A study of low level vibrations as a power source for wireless sensor nodes,” Computer Communications, 26(1):1131-1144, July 2003 ). For example, vibrational energy can be translated into electrical energy through piezoelectric materials that induce an open circuit voltage when placed under mechanical stress. While using vibration as an energy source is promising, the power output is limited to the order of a hundred μW (for mote-size devices). The PicoRadio project out of UC Berkeley built a proof-of-concept transmitter that operates at very low duty cycles while powered off of solar and vibrational energy (S. Roundy, B. P. Otis, Y.-H. Chee, J. M. Rabaey, and P. Wright, “A 1.9 GHz RF Transmit Beacon using Environmentally Scavenged Energy,” In Proc. ISLPED, August 2003). Based on these demonstrations and the belief that energy-harvesting technology will improve, a design target of for the present invention was set at 100 μW, although the present invention may be used with systems having lower or higher power.

The design approach of the present invention studies all levels of the system design from the applications down to the circuits and even the choice of process technology. This holistic approach enables the present invention to uncover architectural and circuit-level design tradeoffs that guide design decisions in order to meet low power goals and long lifetime requirements. The power target of the system architecture is 100 μW for normal workloads. This power level was chosen with the ultimate objective of implementing a truly untethered device that can operate indefinitely off of energy scavenged from the environment.

The intermittent, event-driven nature of sensor network application workloads motivates several architectural design features. The present invention optimizes the architecture for frequent, repetitive behavior that is characteristic of sensor network applications. These optimizations include hardware acceleration and offloading immediate event handling from the general purpose computing component. Features such as event-driven computation improve performance (thus permitting a slower system clock) and reduce power consumption by eliminating unnecessary operating system overhead. In order to meet the long-lifetime demands of many wireless sensor network deployments, our architecture enables fine-grain power management to minimize extraneous dynamic and static power consumption. Efforts to minimize idle (or leakage) power has led us to investigate tradeoffs between process technology generations. Given the relatively low performance requirements of the sensor nodes, we argue that the most advanced process technology is not necessarily the lowest power solution.

The present invention leverages active systems research in wireless sensor networks to provide insights and details of power consumption in currently available hardware platforms. We first set out to determine whether efforts to reduce power in the computational component of a sensor node is warranted, dictated by Amdahl's law. Power consumed for radio communication is generally recognized to be significant and is the focus of much research effort to reduce power consumed by the circuitry itself and to minimize radio usage (J. Polastre, J. Hill, and D. Culler, “Versatile Low Power Media Access for Wireless Sensor Networks,” In Proceedings of the Second ACM Conference on Embedded Networked Sensor Systems (SenSys '04), Baltimore, Md., November 2004 and Y. Xu, J. Heidemann, and D. Estrin, “Geography-informed EnergyConservation for Ad Hoc Routing,” Proceedings of the Seventh Annual ACM/IEEE International Conference on Mobile Computing and Networking (ACM MobiCom), Rome, Italy, July 2001). While radio power is indeed significant, power required for computation can also be appreciable. The PowerTOSSIM project (V. Shnayder, M. Hempstead, B.-R. Chen, G. W. Allen, and M. Welsh, “Simulating the Power Consumption of LargeScale Sensor NetworkApplications,” In Proceedings of the Second ACM Conference on Embedded Networked Sensor Systems (SenSys '04), Baltimore, Md., November 2004) studied the power consumption of the widely used Mica2 mote available from Crossbow. A summary of power consumed by the CPU, sensors, and radio is presented in Table 1.

TABLE 1
Mica2 platform current draw measured with a
3 V power supply.

| Device/Mode | Current | Device/Mode | Current |
|---|---|---|---|
| CPU | | Radio | |
| Active | 8.0 mA | Rx | 7.0 mA |
| Idle | 3.2 mA | Tx (−20 dBm) | 3.7 mA |
| ADC Acquire | 1.0 mA | Tx (−8 dBm) | 6.5 mA |
| Extended Standby | 0.223 mA | Tx (0 dBm) | 8.5 mA |
| Standby | 0.216 mA | Tx (10 dBm) | 21.5 mA |
| Power-save | 0.110 mA | Sensors | |
| Power-down | 0.103 mA | Typical Board | 0.7 mA |

The table shows that active CPU and radio power numbers are comparable. Given the ability to operate the CPU in both active and idle (or lower power) modes, these numbers do not present the complete picture. The computational demands of the application determine the CPU's actual activity and radio usage. The PowerTOSSIM paper provides a detailed breakdown of energy consumed by different components for a variety of applications. In these results, the CPU power ranges from 28% to 86% of the total power consumed and roughly 50% on average. Furthermore, data filtering and more efficient communication protocols can shift activity from the radio to the CPU. Although there may be ways to reduce CPU power in existing hardware platforms, there is an innate inefficiency associated with using general purpose CPUs for sensor network workloads. Simulation results reveal the potential for significantly reducing power consumption when the computational unit uses an architecture designed to leverage the event-driven nature of sensor networks.

A general understanding of wireless sensor network application space assists in understanding the computational needs of sensor network workloads. Hardware requirements vary widely depending on the projected lifetime, computational complexity, and communication needs of the deployment. The monitoring class of applications, characterized by low duty cycles, long deployment lifetimes, and regularity of operation are used as an example in the present description because they provide well-defined and interesting constraints for sensor node design. The present invention, of course, may be used in conjunction with other classes of sensor applications as well.

Typical monitoring applications can be broken down into a clear set of regular tasks. Nodes typically complete several data generation tasks that include taking sensor samples, preparing messages containing data, and sending radio messages. Nodes also complete ad-hoc routing tasks such as receiving messages, looking up routing information, and sending radio messages. The interval of sensor readings depends on the phenomenon being measured and these rates are typically very low. UC Berkeley's Great Duck Island (GDI) application measured all sensors every 70 seconds, then transmitted a packet. Harvard's deployment of sensor nodes to measure infrasound on the Tungurahua volcano measured samples at 100 Hz and sent 4 radio messages a second with 25 samples per packet (Geoffrey Werner-Allen and Matt Welsh, “Monitoring volcanic eruptions with a wireless sensor network,” http://www.eecs.harvard.edu/˜werner/projects/volcano/). While both of these applications transmitted to a base station that was one hop from the sensor nodes, other deployments may require nodes to also serve as communication relays due to large physical separation between nodes. The ultimate goal of a monitoring deployment is to provide continuous sensing for years to decades without being touched. Past deployments of sensor networks for environmental monitoring had limited lifetimes (a few weeks or months) due to the relatively high power consumption of commodity hardware. Therefore, an ultra low power system is required to achieve these deployment goals. The next section describes the goals and implementation of our architecture, which is designed specifically for this application class.

The present invention replaces most of the functionality of a general purpose microcontroller with an event-driven system specifically optimized for monitoring applications. A summary of some of the design goals met by the present invention are presented below and detailed discussions of goals and how the present invention meets these goals follows.

1. Event-Driven Computation: Eliminate unnecessary event-processing overhead with an event-driven hardware platform.

2. Hardware Acceleration to Improve Performance and Power: Build a system composed of several components that are optimized for specific tasks.

3. Exploiting Regularity of Operations within an Application: Optimize the common-case behavior within an application.

4. Optimization for a Particular Class of Applications: Optimize the common-case behavior of monitoring applications to reduce power, while still providing general-purpose processing capability to enable broad functionality.

5. Modularity: Provide an easily extensible system architecture that allows different sets of hardware components to be combined into a larger system targeting a particular application.

6. Fine-grain Power Management Based on Computational Requirements: Provide explicit programmer accessible commands for fine-grain resource and power control.

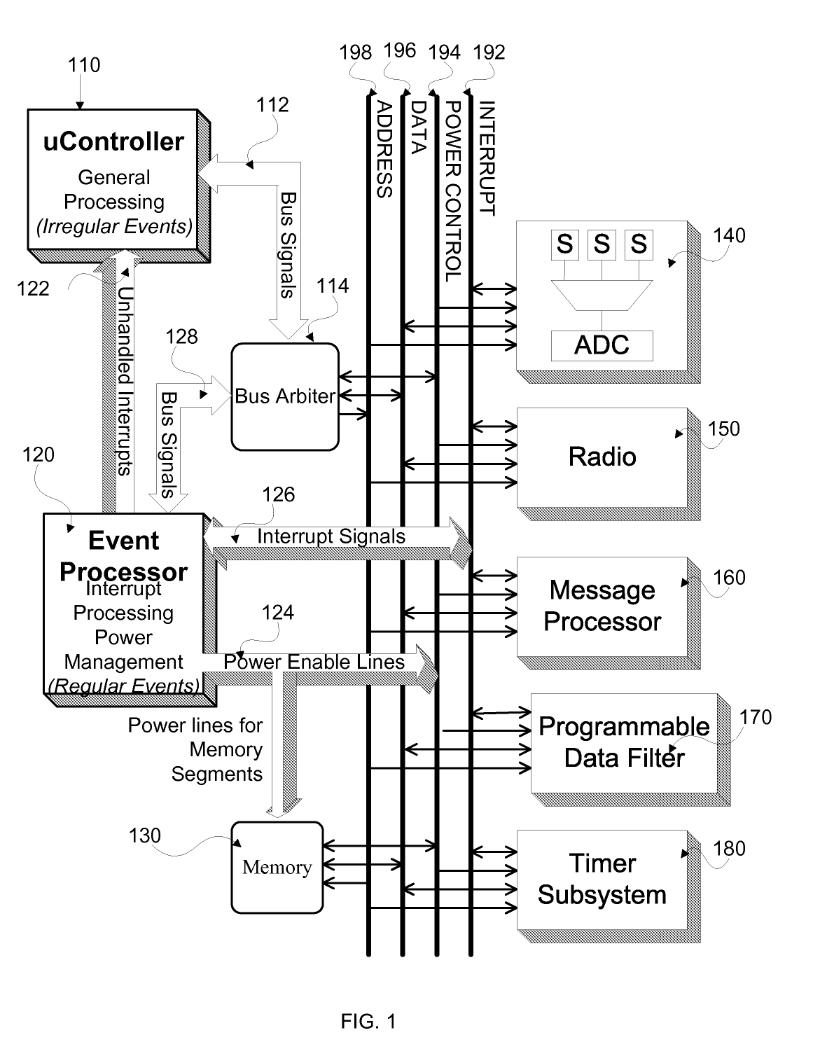

To fulfill these and other design goals, the present invention replaces the basic functionality of a general-purpose microcontroller with a modularized, event-driven system. The system architecture of the present invention is illustrated in FIG. 1. There are two distinct divisions within the system in terms of the positions of the components with respect to the system bus 190. The components to the right of the system bus 190 as slave components and those to the left as master components (except the memory 130, which is a slave). The system bus 190 has three divisions—data 196, interrupt 192, and power control 194. The slaves compete for the interrupt bus 192 using centralized arbitration if more than one slave has an interrupt to signal. The slaves also respond to read or write requests from the master side on the data bus 196, thus allowing the masters to read their information content and control their execution. Power control lines 194 are explained later.

The features of the architecture are best understood in the context of design goals listed above. The present invention is an event-driven system in which all of the master components are involved with event handling, and the slaves assist the master components in their tasks and signal the occurrence of events to trigger the master components. All external events, such as the beginning of radio packet reception, are expressed as interrupts by an appropriate slave component. The slave components also raise interrupts for their internal events, such as completion of an assigned task. To the master components, there is no distinction between external and internal events. Also, since the occurrence of all events is signaled by interrupts, we will use the terms event and interrupt interchangeably. The system idles until one of the slaves signals the presence of an event, and when all outstanding events have been processed, the system returns to its idle mode. Since all the system does is respond to events, there is no software overhead for interrupt handling.

There is a general-purpose microcontroller 110 in the system of the present invention. However, unlike other sensor network device architectures, the intent of the present design is for the microcontroller 110 to be the last resort for any computation, i.e. the microcontroller 110 should be called upon to perform a task only if the rest of the system does not have the requisite functionality. Specific tasks that are considered common to a wide variety of application are offloaded to hardware accelerators, which can be more power and cycle efficient than the general purpose microcontroller. Hence, the microcontroller 110 can usually be powered down by gating the supply voltage. This not only reduces active power but also leakage, which can be a very significant source of power consumption for low duty cycle operation. Some questions that arise are: How are the hardware accelerators configured for their tasks? How are interrupts handled while the microcontroller is asleep? The answers to these questions are deferred to the discussion of how the architecture exploits regularity of operations.

All of the hardware accelerators in the system are slave components. There is a timer subsystem 180 that sets alarm events, which may be used to sample data from the sensors, in a Time-Division Multiple Access (TDMA) radio scheme, or for any tasks to be performed at regular intervals. In the absence of a hardware timer, a software timer would have to be implemented in the microcontroller, requiring the microcontroller to always be active. There is a generic filter slave 170 for basic data processing. In a preferred embodiment of the present invention, this block is a simple threshold filter with a programmable threshold. A preferred embodiment further has a message processor 160 to offload packet processing and avoid waking up the microcontroller 110 for common events such as packet forwarding and transmitting packets of collected samples. The slave components also include essential sensor network device components such as the radio 150, and a block of sensors and Analog-to-Digital Converters (ADCs) 140.

All immediate interrupt handling is offloaded to the event processor 120 while the microcontroller 110 is powered down. The event processor 120 is a simple state machine that can be programmed to handle an interrupt by transferring data blocks between the slave devices and setting up control information for these devices to complete their tasks.

The event processor 120 can also be programmed to wake up the microcontroller 110 if the requisite functionality for processing the interrupt is not otherwise available. To some extent, the event processor 120 can be perceived as an intelligent DMA controller. Thus, there are two levels of interrupt service routines (ISRs) to handle an interrupt: at the event processor level and at the microcontroller level. ISRs for both the event processor and the microcontroller are stored in the main memory, which is a unified instruction and data memory connected to the bus.

We now elaborate further on the notion of regular and irregular events. A regular event is one that can be processed wholly by the event processor and the slave components. An irregular event is one that requires the microcontroller. One of the tasks involved in mapping an application to the system of the present invention is to determine the partitioning of events into regular and irregular events. The regularity of an event is determined by the functionality present in the slaves and the event processor. For a typical application, events such as sampling, transmitting samples, and forwarding packets would ideally be regular while application or network reconfigurations would often be classified as irregular.

All of the slave devices are attached to the system bus and are memory-mapped. Both control and data are communicated to and from the slaves by simply reading from and writing to appropriate addresses in the memory. Thus, the event processor is not aware that data is being transferred between separate slaves, or that control information is being written to the slaves. This memory mapped interface allows the system design to be extremely modular and new components (and hence new functionality) can be added on to the system bus without modification of the event processor or the microcontroller.

Since the master components are triggered by interrupts, the ISRs for each interrupt can configure the system according to its computational requirements for handling the interrupt. To sufficiently curb leakage power, special instructions within the event processor are used to gate the supply voltages of system components. Note that the system does not infer the resource usage for an event; rather, the ISR programmer selects the components to turn on depending on the needs of the application. Individual power enable lines are required for each component under direct control. Vdd-gating and power down implementations will vary depending on the circuit-level design of the individual slave components. Such power control may not only be exercised over the slave components, but also over segments within the main memory that contain temporary data, such as application scratch space. The event-driven programmable resource usage in systems in accordance with the present invention allows configuration of system power consumption with very little logic overhead, as opposed to a technique that attempts to infer resource usage. Also, it allows the addition of several specific components to the system as slaves that can be used in varying combinations to provide the functionality required by an application. Any component unused in an application can be turned off (i.e., supply voltage gated) and is nearly invisible during the entire lifetime of the application. Therefore, the system can satisfy the general-purpose requirements of applications by providing a broad range of slave components, enabling an on-demand functionality that imposes negligible overhead when a component is not required.

Some of the system components of a preferred embodiment of the present invention are now described in greater detail.

System Bus. As discussed earlier, the system bus 190 comprises the data bus 196, the interrupt bus 192, and power control lines 194. The data bus 196 has address, data, and control signals indicating read and write operations. In a preferred embodiment, the address bus 198 has 16 lines, the data bus 196 has 8 lines, and there is one control signal each for read and write operations. The address space for a preferred embodiment of the memory-mapped architecture is therefore 64K. The address and control lines can be driven only by the event processor and the microcontroller in mutual exclusion as determined by the bus arbiter, which is currently just a mux. The data lines are driven by the slave that determines that the current request lies in its address range, and are demultiplexed to the originator of the request, i.e., the event processor or the microcontroller.

The interrupt bus 192 has 6 address lines and control signals for arbitrating the writing of interrupts by slaves. The system is therefore capable of handling 64 interrupts in the current model. The event processor 120 has control signals in the interrupt bus 192 to indicate when it has read the current interrupt address.

The power control lines are handshake pairs for each slave or memory segment controlled. The handshake is relevant only when a component is turned on, to determine the time when the component can be used. The system currently makes no assumptions about the time taken to wake up for the components over which explicit power control is exercised. This preferred embodiment of the system bus is merely exemplary, as other designs of the system bus will be apparent to those of skill in the art.

Microcontroller. The microcontroller 110 is used to handle irregular events, as discussed in previous sections, such as system initialization and reprogramming. In a preferred embodiment, the microcontroller is a simple non-pipelined microcontroller. It implements an 8-bit Instruction Set Architecture (ISA).

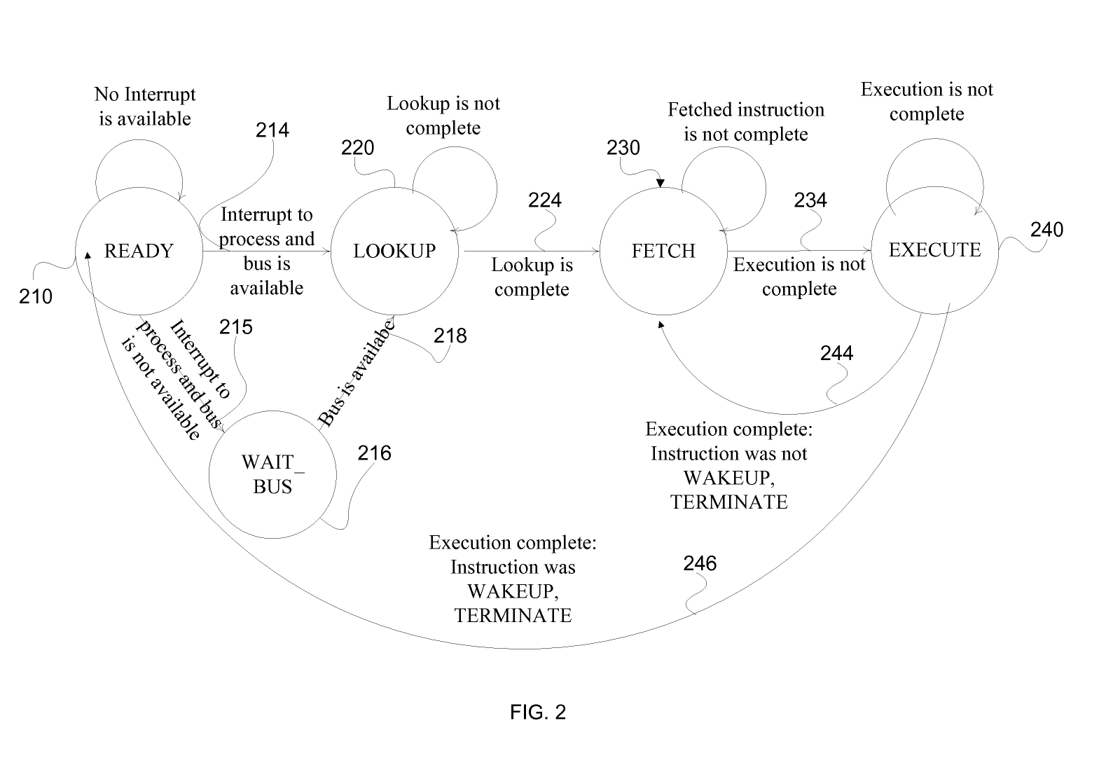

Event Processor. In a preferred embodiment, the event processor 120 is essentially a programmable state machine designed to perform the repetitive task of interrupt handling. FIG. 2 illustrates a simplified version of the actual state machine within the event processor. Because the event processor is an important component of our architecture we now explain its functionality in detail. The event processor idles in the READY state 210 until there is an interrupt to process 214. When an interrupt is signaled, the event processor transitions to the LOOKUP state 220 if the data bus is available 218, i.e., the microcontroller is not awake. If not, the event processor transitions to the WAIT BUS state 216 and waits until the microcontroller relinquishes the data bus. In the LOOKUP state 220, the event processor looks up the ISR address corresponding to the interrupt. The lookup table is stored in memory, and the starting location of the table, offset by an amount proportional to the interrupt address, contains the address of the event processor ISR. When the lookup is complete 224, the event processor transitions to the FETCH state 230, in which the first instruction at the ISR address discovered in the LOOKUP state 220 is fetched. The event processor stays in the FETCH state 230 until all the words of the current instruction have been fetched, and then it transitions to the EXECUTE state 240.

The instructions within an event processor ISR can be, for example, one of the following—SWITCHON, SWITCHOFF, READ, WRITE, WRITEI, TRANSFER, TERMINATE, or WAKEUP. Table 2 provides a summary of the operations corresponding to the instructions. The event processor has one register used to store temporary data. The op-codes are each 3 bits and the instructions vary in the number of words they span.

TABLE 2
Event Processor Instruction Set

| Instruction | Size | Description |
|---|---|---|
| SWITCHON | One word | Turn on a component and wait for acknowledgment that the component is ready to proceed |
| SWITCHOFF | One word | Turn off a component |
| READ | Three words | Read a location in the address space and store to the register |
| WRITE | Three words | Write a location in the address space from the register |
| WRITEI | Three words | Write an immediate value to a location in the address space |
| TRANSFER | Five words | Transfer a block of data within the address space |
| TERMINATE | One words | Terminate the ISR without waking up the microcontroller |
| WAKEUP | Two words | Terminate the ISR and wake up the microcontroller at a microcontroller ISR address |

The EXECUTE state 240 holds until the instruction has been completely executed 246, e.g., the complete transfer has been completed for a TRANSFER instruction. A component is completely powered on for the SWITCHON instruction. If the instruction is not a WAKEUP or TERMINATE instruction, the event processor 120 returns to the FETCH state 230 and fetches the next instruction in the ISR for execution. For WAKEUP or TERMINATE instructions, the event processor returns to the READY state 210 and waits for the next interrupt. This section describes only one embodiment of the event processor. Other embodiments and implementations of the event processor are possible depending on the specific implementation of the invention and such other embodiment will be apparent to those of skill in the art.

Timer Subsystem. The timer subsystem 180 consists of a set of four 16-bit timers in a preferred embodiment of the present invention. Each timer is essentially a counter that counts down to zero from a pre-configured value, and then generates an alarm event. The timers can be chained to allow alarm events to be generated for larger intervals of time. Each timer can be paused, disabled, and reconfigured.

Message Processor. The present invention enables hardware accelerators designed for specific tasks. For example, the present invention uses a message processor block to handle regular message processing tasks, including message preparation and routing. Simple tasks such as table lookup and check-sum calculations can be sped up using hardware implementations (with low power overhead).

In a preferred embodiment, the message processor interface has two memory blocks for each message as well as memory-mapped control words. Other arrangements are possible and will be understood by those of ordinary skill in the art. Data is transferred to the message processor from sensor devices and once the message has been prepared the message processor 160 fires an interrupt and the message is sent to the radio 150. All incoming messages are transferred from the radio 150 to the message processor 160. If the message is a regular message, the message processor looks up whether the message should be forwarded. If the message is an irregular message, then an interrupt is fired and the event processor 120 wakes up the microcontroller 110. The message processor model may, for example, handle standard 802.15.4 packets (ZigBee Alliance, http://www.zigbee.org. IEEE 802.15.4 Standard).

Radio. Like the new Telos mote, the present invention interfaces with the radio 150, which, for example, may be a low-power CC2420 802.15.4 radio from ChipCon. This radio 150 provides hardware support for tasks such as start-symbol detection, error detection, etc., and the present invention may take advantage of these features as they are consistent with the system design approach.

In addition to architectural innovations, circuit techniques and the choice of process technology can significantly impact the power consumed by the sensor nodes. This section presents the results of a process technology simulation study and the architecture and circuit design of a low-power SRAM. Traditionally, the choice of process technology has been straight forward. To push the envelope of performance, the most advanced technology with the smallest feature size and smallest parasitic capacitance should be used. However, subthreshold leakage current is becoming a significant fraction of the total power in designs that use advanced deep-submicron process technologies (International technology roadmap for semiconductors. Semiconductor Industry Association, 2004). When choosing a process technology for sensor network hardware one must choose the technology that considers both active and leakage power in the context of low duty cycle operation.

To study the power and performance tradeoffs of different technologies, we ran a comprehensive set of HSPICE simulations for several eleven-stage ring oscillators comprised of various static CMOS gates. Simulations were run across a wide range of temperatures, supply voltages, and process technologies. Transient simulation results of the oscillators generated active power data. Leakage power was simulated by disabling the feedback in the ring.

Given the characteristically low workload requirements of sensor network applications, leakage power is a major concern. Several researchers have studied and modeled leakage power, but they do not compare different process technologies (S. Borkar, “Design challenges of technology scaling,” IEEE Micro, pages 23-29, July-August 1999; D. J. Frank, R. H. Dennard, E. Dowak, P. M. Solomon, Y. Taur, and H.-S. P. Wong, “Device Scaling Limits of Si MOSFETs and Their Application Dependencies,” Proceedings of the IEEE, 89(3):259-288, March 2001; S. Narendra, V. De, S. Borkar, D. Antoniadis, and A. P. Chandrakasan, “Full-chip sub-threshold leakage power prediction model for sub-0.18 μm cmos,” Proc. ISLPED, August 2002; and R. Rao, A. Strivastava, D. Blaauw, and D. Sylvester, “Statistical analysis of subthreshold leakage current for vlsi circuits,” IEEE Transactions On VLSI Systems, 12(2):131-139, February 2004). Our simulation results show that even with aggressive voltage scaling, deep sub-micron technologies incur higher leakage current penalties, which discourage their use for sensor network applications.

Older technologies with higher threshold voltages exhibit lower leakage current than newer, faster technologies that utilize lower threshold voltages to enable aggressive voltage scaling. However, advanced deep sub-micron technologies consume less active power. We assume a synchronous design that operates off of a globally distributed clock.¹ To account for both sources of power, we used Equation 1 to model the active and leakage power tradeoff,
Pₜₒₜₐₗ=α(T/T_{target})P_{active}+(1−α(T/T_{target}))P_{leakage} (1)
where α is the activity factor and T_{target} is the maximum expected cycle time required to accommodate all applications. We chose 30 μs, which is the time a typical 802.15.4 radio takes to transmit one byte of data. T, P_{active}, and P_{leakage} are the measured period of oscillations, active power, and leakage power, respectively, for each technology node, temperature, device, and voltage simulated.

To provide an example of optimization of the power consumed by a preferred embodiment of the present invention, a 2-kilobyte custom on-chip SRAM was designed. The architecture's overarching paradigm of switching off unneeded circuit elements is present in the memory. For example, the SRAM is divided into banks of 256 bytes to allow unused portions of memory to be Vdd-gated. Both leakage power and active power can be reduced through this banked architecture. By partitioning the memory, the voltage supply to unused banks can be shut off through Vdd-gating, resulting in over a 98% reduction in power drawn by the memory bank—when not Vdd-gated the bank draws 66.5 pW of power, compared to less than 1 pW when gated. It takes 950 ns (or less than one clock cycle) to power up a bank after it has been gated.

The SRAM was layed out in a 0.25 μm technology and the extracted netlist (with parasitics) was simulated using Nanosim (Synopsys Corporation. NanoSim—High capacity and high performance circuit simulation,” http://www.synopsys.com/products/mixedsignal/nanosim/nanosim.html). The power characteristics for a single bank of memory with all associated control circuitry are summarized in Table 3.

TABLE 3
Power for a Single 256B Bank and All Associated
Control Circuitry (V_{supply} = 1.2 V)

| Active Power | Idle Power | Gated Power |
|---|---|---|
| 1.93 μW | 409 pW | 342 pW |

The 2-kilobyte SRAM design consumes 2.07 μW while operating at 100 kHz and 1.2V.

Future revisions of the memory may also include an intelligent precharging scheme. Precharging each bitline consumes the most power when a bank is active, so we envision reducing this power by only precharging the bitlines of the cells that will be accessed. In order to do this we will have to include additional decoder and precharge control circuitry. However, we believe this cost will be offset by a 35% reduction in total active power when this scheme is implemented.

While the performance requirements of wireless sensor nodes are very low, the performance of our architecture relative to general-purpose microcontrollers is an important issue, because it determines the minimum required clock rate of our system. In this section, we present our performance modeling methodology and cycle-level comparisons between our architecture and the Atmel Atmega128 microcontroller used in the Mica2 sensor node.

We used a cycle-accurate simulator written in SystemC to characterize the cycle-level behavior of our architecture. SystemC is a set of C/C++ libraries that is used to model high level architectural behavior (Open SystemC Initiative. SystemC. http://www.systemc.org). Currently, the simulator has 8000 lines of code (excluding SystemC library code). We implemented a modular design to which models of slave components can be easily attached. The SystemC model allowed us to explore several design choices rapidly until we arrived at the current version of our architecture. We also utilized this model to provide component utilization statistics that allowed us to perform power analysis for various workloads.

The simulator can currently take in assembly code for both the microcontroller and the event processor, as well as other simulation data required such as received data packets and data sampled by the sensor block. Thus, it is possible to specify complete applications. A few applications were mapped to the simulator by hand (we are considering compilation from higher-level languages). The same applications were also ported to a simulator for the MICA platform, and the cycle counts for both platforms were collected and compared.

In order to evaluate our architecture, we began with the simplest application that is representative of existing real-world applications such as habitat monitoring. We then added complexity to this application in stages and the final application is fairly complex, including standard sensing and transmission of data, multi-hop routing, and remote application reconfiguration.

We describe the four application versions according to the complexity added in each stage:
1. Periodically collect samples and transmit packets containing the samples.
2. Periodically collect samples and transmit packets containing the samples if it is above a certain threshold.
3. Receive and forward incoming messages from other sensor nodes.
4. Receive and handle incoming reconfiguration messages. (These messages include changes to the sampling period and the sensor threshold value.)

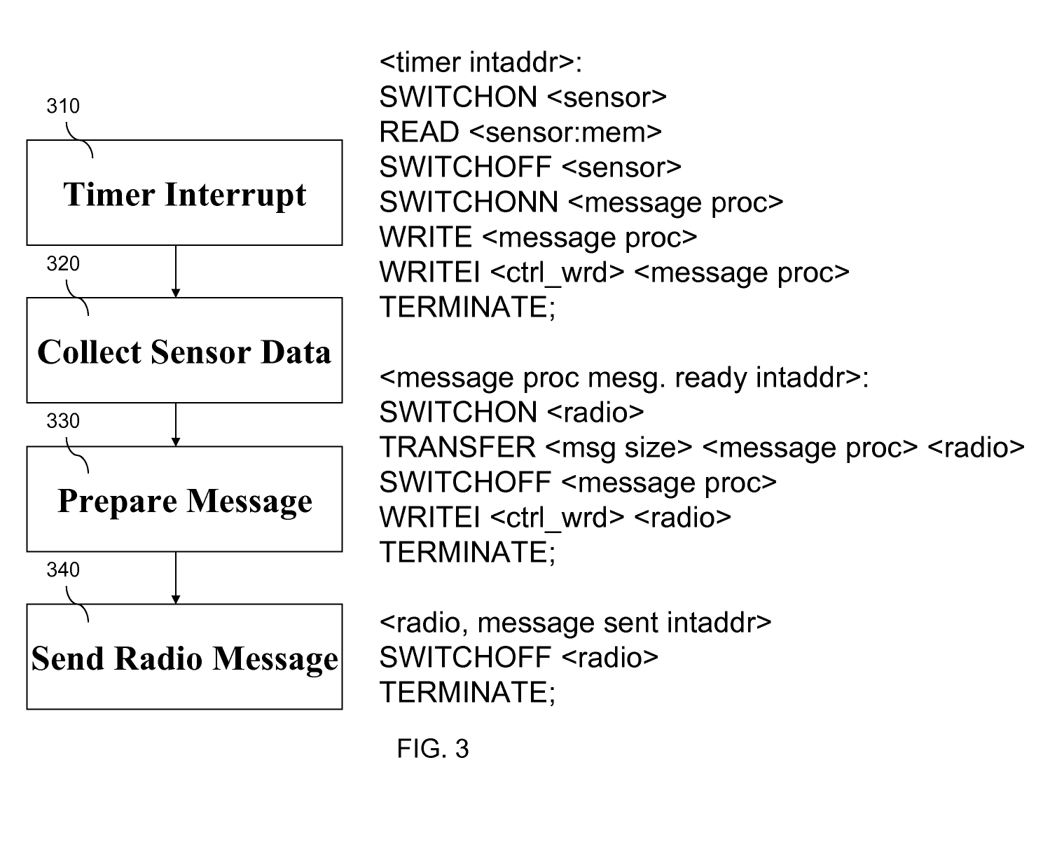

The base application collects samples and transmits the packets. For our architecture, the processing of a sample is initiated by the timer firing an interrupt. The event processor responds to this interrupt by sampling the ADC and transferring the value to the message processor. The message processor prepares the message and signals an event that causes the event processor to transfer the packet to the radio block and setup the radio for transmission. The pseudo-code for the program that runs on the event processor for this application is shown in FIG. 3. Similarly, the second version of the application includes a very simple threshold filtering operation.

In a multi-hop routing environment, message forwarding is expected to be a fairly frequent activity and we, therefore, map it as a regular event in our architecture. When a message arrives, an interrupt is fired by the radio block to indicate that a packet has been received. The event processor responds by transferring the packet to the message processor, which signals whether the message has been previously received (this is performed by searching for the packet ID in the routing table). If the message has been previously received, the packet is dropped, otherwise the event processor sets up the radio to forward the packet.

The last version of the test application contains two irregular events that require intervention from our general purpose microcontroller. In this case, message handling is the same as in the preceding case until the message processor receives the packet. If the message processor determines that the message is not a simple forwarding request, then it signals an interrupt indicating that intervention by the microcontroller is required. The event processor wakes up the microcontroller in response to an irregular event signaled by the message processor. The microcontroller decodes the message to determine whether the timer needs to be recon-figured or whether the filter threshold needs to be modified.

Cycle count results using our SystemC simulator and the Mica2 cycle simulator, Atemu (M. Karir, J. Polley, D. Blazakis, J. McGee, D. Rusk, and J. S. Baras, “ATEMU: A Fine-grained Sensor Network Simulator,” Proceedings of First IEEE International Conference on Sensor and Ad Hoc Communication Networks (SECON'04), Santa Clara, Calif., October 2004), for each application task are shown in Table 4.

TABLE 4
Comparison of cycle count for the test application written on our
architecture and on TinyOS for the Mica Platform.

| | | Our | |
|---|---|---|---|
| Measurement | Mica2 | System | Speedup |
| Total send path w/out filter | 1522 | 102 | 14.9 |
| Total send path w/ filter | 1532 | 127 | 12.1 |
| Process regular message | 429 | 165 | 2.6 |
| Process irregular message | | | |
| Timer change | 234 | 136 | 1.7 |
| Threshold change | 11 | 114 | 0.096 |
| Units | Cycles | Cycles | % |

Each row represents the measurement of a particular segment of code. The first two rows provide measurements of the send path of our application as described previously. The next two rows display cycle comparisons of the receive path for both regular and irregular messages. Our architecture assumes the use of 802.15.4 compatible radios like the CC2420 from ChipCon, which implements the radio stack in hardware. Therefore, to ensure an accurate comparison we did not count the cycles for the instructions in the TinyOS radio stack run on the Mica2.

“For the Mica2 platform, processing a sample includes the software-equivalent implementation of our test applications, in addition to the overhead of TinyOS, required for context switching and task scheduling. Our architecture handles task scheduling natively in the design and, therefore, we see a large difference in cycle counts. Because our architecture is optimized for regular events, it does not show improvements for irregular tasks that require the general purpose microcontroller.

It is clear that the emphasis of our proposed architecture, for typical events seen within a sensor node, has significant cycle-count advantages over commodity systems. These advantages enable our architecture to operate at significantly lower clock rates while maintaining sufficient performance to keep up with the 802.15.4 radio standard and process sensor data requests at a level required by typical applications.

For the Mica2 platform, the applications were written using the TinyOS component library. Because the test applications can be created using typical TinyOS components, programming these applications is straight forward. However, the code size of the final application incorporating all components was 11558 bytes for instructions when ported to the Mica2 platform. This is significant compared to the 180 byte memory footprint required for our system.

Ideally, one would like to compare our results with other designs specifically tailored for sensor networks such as the SNAP architecture. Unfortunately, this is complicated by the fact that the SNAP paper and results assume the older radio chip and software stack, and we do not have access to their simulation environment. Hence, we can only compare two relatively simple applications that were reported in the paper: blink, which sets a timer to periodically interrupt the processor to blink an LED; and sense, which periodically samples data from the ADC and computes a running average. From the published results, SNAP takes 41 cycles and 261 cycles respectively, while our architecture can complete these operations within 12 cycles and 24 cycles. For comparison, the Mica2 requires 523 cycles to run blink and 1118 cycles for sense.

As can be seen from Table 4, the number of cycles taken to process one timer event for the sample, filter, and transmit application takes 127 cycles. The cycle count at 100 KHz gives us a maximum sample rate of roughly 800 samples/second. This maximum rate seems very reasonable considering the fact that most documented sensor network applications have sample rates less than a 100 samples/second. It should also be noted that the clock rate was chosen to accommodate the radio communication data rate of the 802.15.4 standard, 250 Kbits/second.

Since the power consumption of our system can be accurately characterized only after a fabricated chip has been measured, we restrict ourselves to obtaining a conservative estimate based on the active power consumption of the system for its most frequent activities, i.e. the processing of regular events. Again, since we expect to use commodity radio and sensor components, we do not consider these components in our estimates. Because we have not completed the floorplan for our system, we also do not currently include power estimates for global routing signals, buses, and clocks, although we do consider local clock driver circuitry.

The event processor is the largest power consumer in the system since this is a component that must always be powered. Moreover, this block has the most complex microarchitecture of all of the components involved with regular event processing. Hence, for this block, we have obtained conservative estimates by going through the complete process of synthesizing a VHDL model, performing placement, routing, and simulating the final netlist. For the other components, we have broken them down into common substructures such as incrementers, comparators, buffers, etc., and estimated the power consumption numbers for all of these components by simulating netlists synthesized for these sub-structures and combining the results. For all of the memories used (including the main memory block), we use the estimates described above.

The power estimates for the main components of the system are presented in Table 5.

TABLE 5
Power Estimates for Regular Event Processing
in the System

| | Idle/Active | Vdd 1.2 (V) |
|---|---|---|
| Event Processor | Active | 14.25 μW |
| | Idle | 0.018 μW |
| Timer | Active | 5.68 μW |
| | Idle | 0.024 μW |
| Message | Active | 2.57 μW |
| Processor | Idle | 0.025 μW |
| Threshold Filter | Active | 0.42 μW |
| | Idle | ˜0.0 μW |
| Memory | Active | 2.07 μW |
| | Idle | 0.003 μW |
| System | Active | 24.99 μW |
| | Idle | 0.070 μW |

The power numbers are shown for active and idle modes (gated clock) of each component at a supply voltage of 1.2V and a clock frequency of 100 KHz. In the subsection on workload analysis, the power estimates are correlated with duty cycle values for sample application workloads to provide a better understanding of the actual power consumption of the system operating under practical situations.

The active power consumption corresponds to a situation in which the event processor always has an outstanding interrupt to handle. Therefore, the event processor is always switching in this mode because it begins to process a new interrupt the moment it gets done with the current one. The idle power corresponds to a duration in which the event processor is not provided an interrupt to handle. Both of these situations are extreme cases that we do not expect in normal situations.

Implementation details of each block were required to provide accurate power estimates. The message processor block is comprised of a CAM (Content Addressable Memory) structure for the routing table, a counter for keeping track of the packets transmitted, and two 32-byte buffers to allow packet processing and transfer to/from the message processor to take place in parallel. The timer block consists of four decrementers with registers to store the current count, zero-detect logic to fire interrupts, and a small buffer to store current timer configuration. The threshold filter consists mainly of a comparator and a register to store the threshold value. Active power estimates are obtained for cases in which the relevant sub-structures within a slave component are always switching, and idle power estimates are obtained for settings in which none of the sub-structures are switching. Finally, the system active and idle power estimates were obtained by summing up the active and idle powers for the components. It is important to note that the idle power numbers do not reflect Vdd-gating as this feature has not been fully characterized for these components.

The active power estimates presented in the previous section are conservative for practical applications since component activity patterns due to application workload were not taken into account. We now correlate the performance and power estimates obtained in above for a real application to obtain power numbers that take into account the utilization of each component of the system. The application we consider for this analysis is the second application described above, i.e. a sample is collected periodically, filtered, and a packet is transmitted containing the sample if it passes filtering. For the sake of simplicity, we assume that the sample is always transmitted, i.e. the sample passes the threshold check. This case is the more conservative one, because it is when the system has to do more work and all components are active sometime during the processing of one sample.

An upper bound on the sample rate is obtained by assigning a utilization ratio of 1 to the event processor, i.e. the event processor is always active. At this utilization ratio for the event processor, the system is processing the maximum rate of 800 samples per second. The power consumption of each component (and the system) is calculated considering the utilization of the component within the system for several event processor utilization ratios, beginning from the limiting ratio of 1. As a point of reference, the volcano deployment has a duty cycle of 0.12 and the GDI experiment has a duty cycle of approximately 0.0001.

The resulting curves for each component and the system total are shown in FIG. 6. For this application, one of the 4 timers in the timer subsystem is always on while the rest are idle. Also, the threshold filter is used for 3 cycles out of the total system 127 cycles per sample, and the message processor is used for 70 cycles per sample. The system power consumption drops to below 2 μW for even reasonably high sample rates.

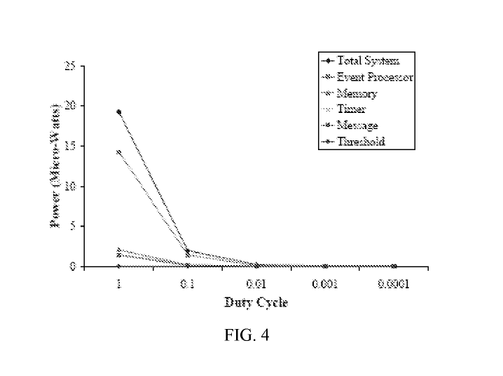

For the purpose of comparison, the power consumption of the Atmel microcontroller is also estimated for the sample rates corresponding to the utilization points of the event processor. The idea is to compare the power numbers for the same work done for both systems, with the utilization of the Atmel microcontroller normalized to those of the event processor in our system. Again, we use the cycle counts presented in Table 4 for the sample-filter-transmit application. For the active and idle power estimates, we use the measured current values for the Atmel microcontroller in Table 1. We found that the trends are similar to FIG. 4 but with a power consumption of a little over two orders of magnitude higher than our architecture.

With the advent of the TI-MSP430 next-generation general-purpose microcontroller used in the Telos mote, the energy consumption difference will likely shrink (Texas Instruments. TI MSP430F149 Ultra-Low Power Microcontroller. http://www.ti.com). For example, the TI-MSP430 reports an active mode power dissipation of between 616 μW and 693 μW at 1 MHz and 2.2V. It has been reported for other sensor network applications that the 32 KHz idle mode, which dissipates power between 44 μW and 123 μW, is the most practical low-power mode for the TI-MSP430 because of the ability to manage peripherals and service interrupts in this mode (P. Zhang, C. Sadler, S. Lyon, and M. Martonosi, “Hardware Design Experiences in ZebraNet,” Proceedings of the Second ACM Conference on Embedded Networked Sensor Systems (SenSys'04), Baltimore, Md., November 2004). If we assume equal cycle-level performance with the Atmel processor, with a sampling rate corresponding to the 0.1 utilization point for our system, the MSP430 will consume between 113 μW and 192 μW. At this time we are unable to compare power results with the SNAP processor because the published results do not include enough data for us to make an accurate comparison.

This work describes a holistic approach to the design of a wireless sensor network device. Employing an application driven design philosophy, this work describes the selection of process technology, circuit design considerations, and a novel system architecture for sensor devices. In order to provide efficient operation and enable fine-grain power control, our architecture provides explicit support for the event-driven nature of sensor network applications and provides key functionality in separate hardware blocks. Our estimates for the key components of the system include a total active power of 25 μW and idle power is ˜70 nW.With a duty cycle of 0.1 or less, the average power drops to less than 2 μW. These results represent a substantial savings over existing systems.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A system for sensor network applications comprising:
a microcontroller for handling irregular events;
at least one hardware accelerator for handling regular events;
an event processor for interrupt handling and power management in said system; and
a system bus;
wherein said microcontroller, said at least one hardware accelerator, and said event processor each are connected to said system bus; and
wherein said event processor gates power to said microcontroller to provide power to said microcontroller only for processing related to irregular events requiring processing by said microcontroller.

2. A system for sensor network applications according to claim 1 wherein said as least one hardware accelerator comprises a plurality of hardware accelerators and wherein said event processor gates power to one of said hardware accelerators to provide power to said hardware accelerator only when said hardware accelerator is needed to perform a task.

3. A system for sensor network applications according to claim 1 further comprising:
a message processor for enabling said hardware accelerator, said message processor being connected to said system bus.

4. A system for sensor network applications according to claim 1 further comprising:
a sensor.

5. A system for sensor network applications according to claim 4 further comprising:
an interface to said sensor.

6. A system for sensor network applications according to claim 1 further comprising:
a radio.

7. A system for sensor network applications according to claim 1 wherein said at least one hardware accelerator can send interrupt signals to said event processor.
